(19) United States
(12) Patent Application Publication
(10) Pub. No.: US 2010/0196606 A1
(43) Pub. Date: Aug. 5, 2010

(54) LIQUID SUPPLYING DEVICE AND METHOD OF USING THE SAME

(75) Inventors: YI FAN PENG, Taipei City (TW); SHU KUO CHIU, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., Taoyuan County (TW)

(21) Appl. No.: 12/422,509

(22) Filed: Apr. 13, 2009

(30) Foreign Application Priority Data
Feb. 4, 2009 (TW) 98103475

(51) Int. Cl. B05D 3/12; B05C 5/02

(52) U.S. Cl. 427/346; 118/300

(57) ABSTRACT

A liquid supplying device includes: a first liquid supplying element, a second liquid supplying element inside the first liquid supplying element, a first driving element connecting to the first liquid supplying element, and a second driving element connecting to the second liquid supplying element. The first liquid supplying element contains a first liquid, and the second liquid supplying element contains a second liquid. Therein the first driving element and the second driving element selectively control the first liquid or the second liquid to spray out from the liquid supplying device. A method of using a liquid supplying device is also provided.

### BACKGROUND OF THE INVENTION

1. Field of the Invention

The present invention relates to a liquid storage and dispensing device for a semiconductor process and a method of using the same, and more particularly to a liquid supplying device and a method of using the same.

2. Description of Related Art

A photoresist coating plays an important role in the semiconductor process, for example it may be used as a mask to protect etched films so that required patterns will not be removed off by etching. Furthermore, in ion implantation, the photoresist coating also offers the mask protecting function because only dopants are allowed to enter into predetermined areas.

Currently, the photoresist coating used in the coating process is in the state of liquid, which is delivered by a pump on a photoresist coating device from a liquid storage unit and then spread over (i.e. to be outputted over) the center of a substrate from a nozzle under the control of a control valve on a piping that is connected to the pump.

Referring to FIG. 1A through FIG. 1D, which are flow charts of a photoresist coating process, a substrate 1a is placed into a coating bath 2a. In order to reduce the usage of the photoresist, a reduced resist consumption (RRC) nozzle 3a which provides a dilutant, the dilutant is then spread over the substrate before the photoresist coating process begins. After the dilutant has spread all over the substrate 1 a, a photoresist nozzle 4a provides the photoresist, and the photoresist then spreads over the substrate 1a. Finally, the substrate 1a is spun to assist the photoresist to completely and evenly distribute over the substrate 1a.

However, the current photoresist coating process for semiconductor manufacturing still has the following disadvantages:

1. The reduced resist consumption nozzle 3a and the photoresist nozzle 4a are separately arranged. When the photoresist is to be spread out, the reduced resist consumption nozzle 3a needs to return to its original position before the photoresist nozzle 4a starts to move to the substrate 1a from its original position. Thereby, it takes longer to finish the photoresist coating process.

2. The photoresist becomes solidified as time elapses. Therefore, the photoresist nozzle 4a might be clogged by the solidified photoresist if the idle time between spreads is too long. In this situation, the photoresist nozzle 4a that has been clogged cannot smoothly spread out the photoresist over the substrate la, thereby disadvantageously reducing the yield.

### SUMMARY OF THE INVENTION

It is one object of the present invention to provide a liquid supplying device which contains two kinds of liquids that may be selectively outputted.

It is another object of the present invention to provide a method of using a liquid supplying device which optionally output one of two liquids contained in the liquid supplying device.

To achieve the above-mentioned objectives, the present invention provides a liquid supplying device which includes a first liquid supplying element, which has a first space for containing a first liquid, and has an opening at one end of the first liquid supplying element so as to communicate with the first space; a second liquid supplying element, which has a second space for containing a second liquid, and is located in the first space with the second space connecting to the opening; a first driving element, which is used to drive the first liquid and connects to the first space, wherein the first driving element drives the first liquid to output through the opening; and a second driving element, which is used to drive the second liquid and connects to the second space, wherein the second driving element drives the second liquid to output through the opening.

To achieve the above-mentioned objectives, the present invention further provides a method of using a liquid supplying device, which includes proving a wafer; moving the liquid supplying device above the center of the wafer and outputting the first liquid over the wafer; spinning the wafer to coat the wafer with the first liquid; outputting the second liquid onto the center of the wafer; and spinning the wafer to coat the wafer with the second liquid.

In light of the foregoing, the liquid supplying device and the method of using the same according to the present invention offer the following advantages over the prior art:

1. The first liquid and the second liquid can both be contained in the liquid supplying device. In the coating process, one of the first liquid and the second liquid can be chosen to be outputted from the liquid supplying device.

2. The period of coating time can be significantly shortened by using the liquid supplying device, which contributes to increase in the yield of wafer manufacture.

In order to further understand the techniques, means, and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1A through FIG. 1D are flow charts of photoresist coating of the prior art;

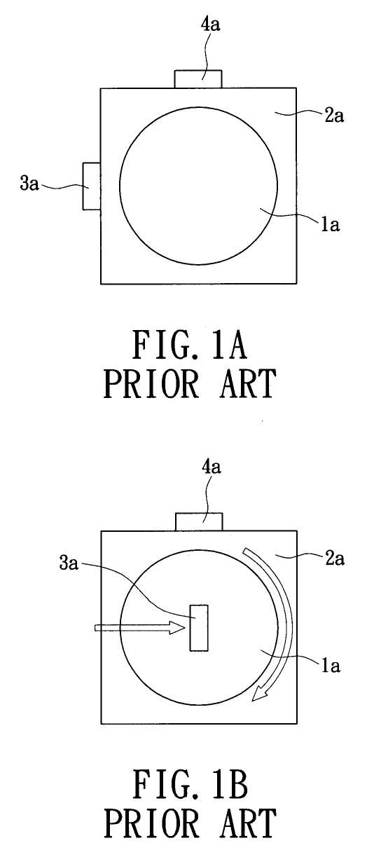

FIG. 2 is a schematic view of a liquid supplying device according to the present invention;

FIG. 3 is a schematic view of a first liquid supplying element and a second liquid supplying element of a liquid supplying device according to a first embodiment of the present invention;

FIG. 4 is a schematic view of a first liquid supplying element and a second liquid supplying element of a liquid supplying device according to a second embodiment of the present invention;

FIG. 5 is a schematic view of a first liquid supplying element and a second liquid supplying element of a liquid supplying device according to a third embodiment of the present invention;

FIG. 6 is a schematic view of a first liquid supplying element and a second liquid supplying element of a liquid supplying device according to a fourth embodiment of the present invention;

FIG. 7 is a flow chart of a method for using a liquid supplying device according to the present invention;

FIG. 8A through FIG. 8E are flow charts of a method for using a liquid supplying device according to the present invention.

### DETAILED DESCRIPTION OF THE PREFERRED EMBODIMENTS

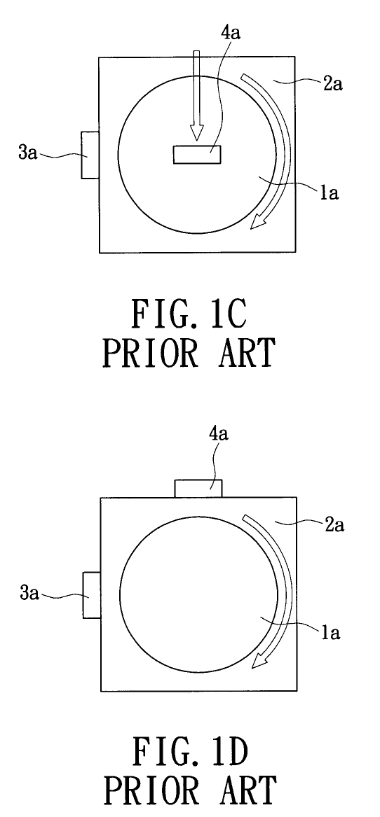

Referring now to FIG. 2, in which a schematic view of a liquid supplying device according to the present invention is shown, the control device 1 is used in a semiconductor process and includes a first liquid supplying element 11, a second liquid supplying element 12, a first driving element 13, and a second driving element 14. The second liquid supplying element 12 is located inside the first liquid element 11. The first driving element 13 connects to the first liquid supplying element 11 and the second driving element 14 connects to the second liquid supplying element 12.

Specifically, the first liquid supplying element 11 has a first space 111 in its interior for containing a first liquid 2. The first liquid supplying element 11 further has an opening 112 located at one end thereof to communicate with the first space 111 so that the first liquid 2 inside the first space 111 can spread out (i.e. be outputted) through the opening 112.

The second liquid supplying element 12 has a second space 121 in its interior for containing a second liquid 3. The second liquid supplying element 12 is located inside the first space 111, with the second space 121 communicating with the opening 112, so that the second liquid 3 inside the second space 121 can be spread out of the second liquid supplying element 12 through the opening 112. It is noted that the second liquid supplying element 12 has an outer diameter D1 smaller than an inner diameter D2 of the first space 111 of the first liquid supplying element 11. With the configuration above, the liquid supplying device can contain two liquids at the same time.

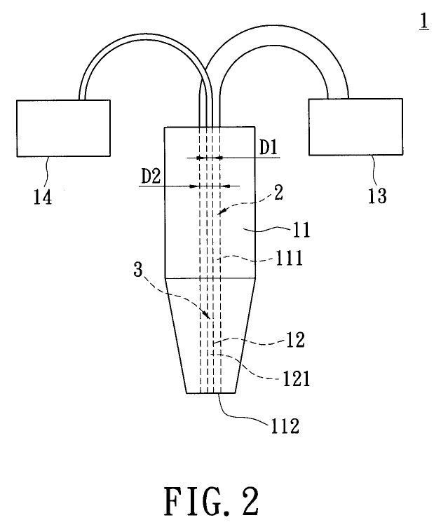

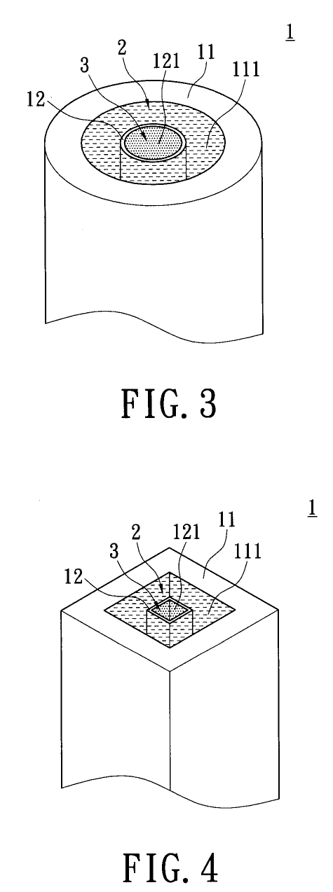

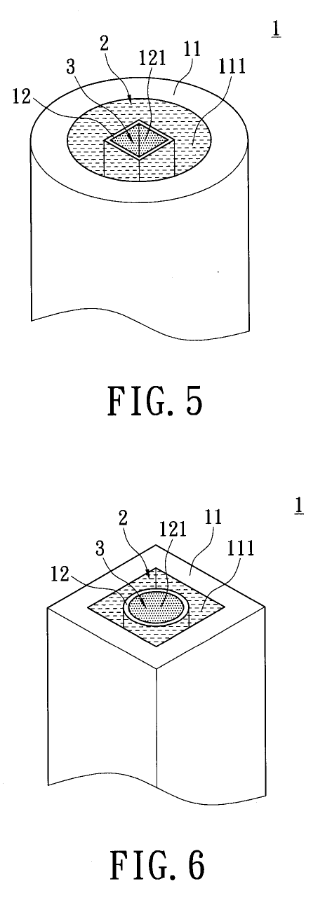

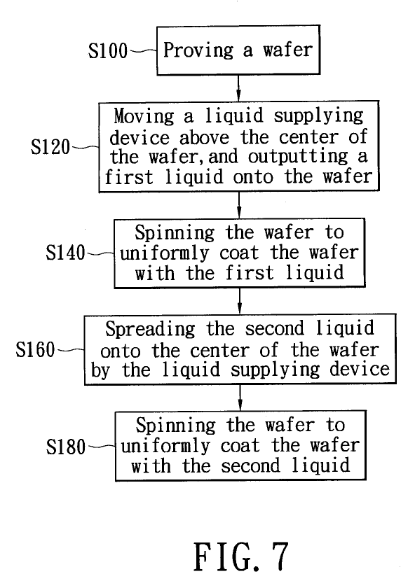

The profiles of the first liquid supplying element 11 and the second liquid supplying element 12 are not particular limited, and can be modified according to actual needs. For example, they can be circular column, rectangular column, or other shapes. In the embodiment shown in FIG. 3, both the first liquid supplying element 11 and the second liquid supplying element 12 are in the shape of circular column. In the embodiment shown in FIG. 4, both the first liquid supplying element 11 and the second liquid supplying element 12 are in the shape of rectangular column. In the embodiment shown in FIG. 5, the first liquid supplying element 11 is in the shape of circular column, while the second liquid supplying element 12 is in the shape of rectangular column. In the embodiment shown in FIG. 6, the first liquid supplying element 11 is in the shape of rectangular column, while the second liquid supplying element 12 is in the shape of circular column. In this embodiment as shown in FIG. 2, both the first liquid supplying element 11 and the second liquid supplying element 12 are in the shape of circular column.

In order to for the first liquid 2 inside the first space 111 and the second liquid 3 inside the second space 121 to spread out (i.e. output) through the opening 112, the first driving element 13 and the second driving element 14 are provided for controlling of the output. The first driving element 13 and the second driving element 14 are pneumatic pumps. The first driving element 13 connects to the first space 111 of the first liquid supplying element 11. The second driving element 14 connects to the second space 121 of the second liquid supplying element 12. The first driving element 13 pneumatically drives the first liquid 2 inside the first space 111 to output through the opening 12. Similarly, the second driving element 14 pneumatically drives the second liquid 3 inside the second space 121 to output through the opening 12. Thereby, the first liquid 2 and the second liquid 3 can be outputted through the same opening 112 by correspondingly controlling the first driving element 13 or the second driving element 14.

The kinds of the first liquid 2 and the second liquid 3 are not particularly limited, and can be chosen according the actual needs. In this embodiment, the liquid supplying device 1 is applied to the semiconductor process and therefore the first liquid 2 inside the first space 111 is a photoresist and the second liquid 3 inside the second space 121 is ethyllactate (EL) or propylene glycolmonomethyl ether acetate (PGMEA). Alternatively, the first liquid 2 inside the first space 111 is ethyllactate (EL) or propylene glycolmonomethyl ether acetate (PGMEA) and the second liquid 3 inside the second space 121 is photoresist.

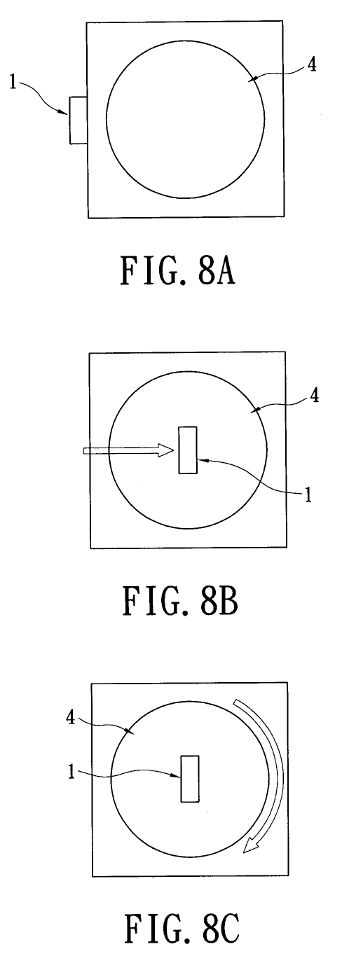

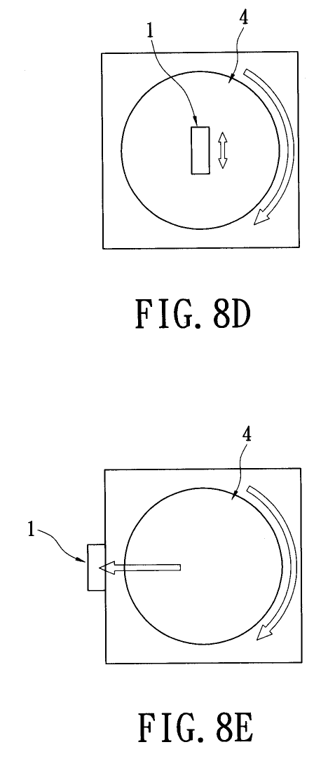

Referring to FIG. 7, FIG. 8A through FIG. 8E, accompanying with FIG. 2, the present invention provides a method of using the liquid supplying device as recited above. The method of using the liquid supplying device can be applied to a coating process in semiconductor manufacture. The method includes the following steps:

S100: Proving a wafer 4

S120: Moving the liquid supplying device 1 above the center of the wafer 4. When the liquid supplying device 1 is above the center of the wafer 4, the first driving element 13 of the first space 111 drives the first liquid 2 inside the first space 111 to spread over (i.e. to be outputted over) the wafer 4 through the opening 112. It is noted that the first driving element 13 is a pneumatic pump which pneumatically pushes the first liquid 2 to output through the opening 112.

S140: Spinning the wafer 4 to uniformly coat the wafer 4 with the first liquid 2 after the first liquid 2 is spread over the wafer 4. The wafer 4 can be spun at different speeds so as to assist the first liquid 2 to spread out uniformly.

S160: Spreading the second liquid 3 onto the center of the wafer 4 by the second liquid supplying element 12 of the liquid supplying device 1 after the first liquid 2 is uniformly coated on the wafer 4. Specifically, the second driving element 14 connecting to the second space 121 pushes the second liquid 3 inside the second space 121 to spread over the wafer 4 through the opening 112. It is noted that the second driving element 14 is a pneumatic pump which pneumatically pushes the second liquid 3 to spread out through the opening 112.

S180: Spinning the wafer 4 to uniformly coat the wafer 4 with the second liquid 3 after the second liquid 3 is spread over the wafer 4. The wafer 4 can be spun at high speed so as to have the second liquid uniformly spread over the wafer 4.

In the above method, the first liquid 2 is ethyllactate (EL) or propylene glycolmonomethyl ether acetate (PGMEA) and the second liquid 3 is a photoresist. That is, ethyllactate (EL) or propylene glycolmonomethyl ether acetate (PGMEA) inside the first liquid supplying element 11 is pneumatically spread over the wafer 4 through the opening 112 by the pressure generated by the first driving element 13. After the first liquid 2 is uniformly spread over the wafer 4, the photoresist inside the second liquid supplying element 12 of the first liquid supplying device 1 is pneumatically spread over the wafer 4 through the opening 112 by the pressure generated by the second driving element 14. Finally, the wafer 4 is spun so as to uniformly coat the wafer 4 with the photoresist. The coating process for the semiconductor manufacture is thereby completed.

In light of the foregoing, the liquid supplying device and the method of using the same according to the invention offer the following advantages over the prior art:

1. The first liquid 2 and the second liquid 3 can be both contained in the liquid supplying device 1. In the coating process, one of the first liquid 2 and the second liquid 3 can be chosen to be outputted from the liquid supplying device 1.

2. The period of coating time can be significantly shortened by using the liquid supplying device 1, further increasing the yield of wafer manufacture.

3. The expensive photoresist which is used in the coating process may become solidified as time elapses. However, some volatile solvents such as ethyllactate (EL), propylene glycolmonomethyl ether acetate (PGMEA) may be used in the coating process so as to help keep the photoresist in liquid state. In the present invention, the photoresist and one or more of the volatile solvents are contained in the same liquid supplying device 1 so that the vapor from the volatile solvent wets the photoresist and therefore prevents the photoresist from becoming solidified. The storage-life-span of the photoresist thereby becomes longer and therefore the production cost can be reduced.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A liquid supplying device, which includes:
a first liquid supplying element, which has a first space for containing a first liquid, and one end of the first liquid supplying element has an opening that communicates with the first space;
a second liquid supplying element, which has a second space for containing a second liquid, and is located in the first space with the second space connecting to the opening;
a first driving element, which is used to drive the first liquid and connects to the first space, wherein the first driving element drives the first liquid to be outputted through the opening; and
a second driving element, which is used to drive the second liquid and connects to the second space, wherein the second driving element drives the second liquid to be outputted through the opening.

2. The liquid supplying device according to claim 1, wherein the second liquid supplying element has an outer diameter smaller than an inner diameter of the first space.

3. The liquid supplying device according to claim 1, wherein the first liquid is a photoresist, and the second liquid is ethyllactate (EL) or propylene glycolmonomethyl ether acetate (PGMEA).

4. The liquid supplying device according to claim 1, wherein the first liquid is ethyllactate (EL) or propylene glycolmonomethyl ether acetate (PGMEA), and the second liquid is a photoresist.

5. The liquid supplying device according to claim 1, wherein the first liquid supplying element and the second liquid supplying element are in the shape of circular column.

6. The liquid supplying device according to claim 1, wherein the first liquid supplying element and the second liquid supplying element are in the shape of rectangular column.

7. The liquid supplying device according to claim 1, wherein the first liquid supplying element is in the shape of circular column and the second liquid supplying element is in the shape of rectangular column.

8. The liquid supplying device according to claim 1, wherein the first liquid supplying element is in the shape of rectangular column and the second liquid supplying element is in the shape of circular column.

9. The liquid supplying device according to claim 1, wherein the first driving element and the second driving element are pneumatic pumps.

10. A method of using the liquid supplying device according to claim 1, which includes the following steps:
proving a wafer;
moving the liquid supplying device above the center of the wafer and
outputting the first liquid over the wafer;
spinning the wafer to coat the wafer with the first liquid;
outputting the second liquid onto the center of the wafer; and
spinning the wafer to coat the wafer with the second liquid.

11. The method according to claim 10, wherein the first liquid is ethyllactate (EL) or propylene glycolmonomethyl ether acetate (PGMEA), and the second liquid is a photoresist.

12. The method according to claim 11, wherein the first driving element of the first space drives the first liquid inside the first space to be outputted over the wafer through the opening.

13. The method according to claim 12, wherein the first driving element is a pneumatic pump which pneumatically pushes the first liquid to be outputted through the opening.

14. The method according to claim 12, wherein the wafer is spun at different speeds so as to assist the first liquid to be outputted uniformly over the wafer.

15. The method according to claim 14, wherein after the first liquid is uniformly coated on the wafer, the second driving element pushes the second liquid inside the second liquid supplying element to be outputted over the wafer through the opening.

16. The method according to claim 15, wherein the second driving element is a pneumatic pump which pneumatically pushes the second liquid to be outputted through the opening.

17. The method according to claim 15, wherein the wafer is spun at high speed so as to have the second liquid outputted uniformly over the wafer.
